(19) United States
(12) Patent Application Publication
(10) Pub. No.: US 2020/0058037 A1
(43) Pub. Date: Feb. 20, 2020

(54) REPORTING OF MEDIA CONSUMPTION METRICS

(71) Applicant: comScore, Inc., Reston, VA (US)

(72) Inventors: Keith Funkhouser, Madison, WI (US); Matthew L. Malloy, Madison, WI (US); Benjamin Itzkowitz, Washington, DC (US); Paul Deitrick, Myrtle Beach, SC (US); Frank E. Pecjak, Fairfax, VA (US); Paul Barford, Madison, WI (US)

(21) Appl. No.: 16/103,679

(22) Filed: Aug. 14, 2018

(51) Int. Cl. G06Q 30/02

(52) U.S. Cl. CPC G06Q 30/0201

(57) ABSTRACT

A reporting server may access a first data set that indicates an association between one or more device identifiers and one or more content identifiers and a second data set that indicates an association between the one or more device identifiers and one or more user identifiers. The reporting server may determine, based on the first data set and the second data set, that at least one user associated with a user identifier of the second data set has accessed content associated with a plurality of the content identifiers of the first data set, and may generate a report that represents, for each content identifier, a number of unique user identifiers associated with the content identifier.

### BACKGROUND

Internet audience measurement may be useful for a number of reasons. For example, some organizations may want to be able to make claims about the size and growth of their audiences or technologies. Understanding consumer behavior, such as how consumers interact with a particular web site or group of web sites, may help organizations make decisions that improve their traffic flow or the objective of their site. In addition, understanding Internet audience visitation and habits may be useful in supporting advertising planning, buying, and selling.

### SUMMARY

Methods and systems are disclosed for de-duplicating audience viewership data. In one embodiment, a reporting server may access a first data set that indicates an association between one or more device identifiers and one or more content identifiers and a second data set that indicates an association between the one or more device identifiers and one or more user identifiers. The reporting server may determine, based on the first data set and the second data set, that at least one user associated with a user identifier of the second data set has accessed content associated with a plurality of the content identifiers of the first data set, and may generate a report that represents, for each content identifier, a number of unique user identifiers associated with the content identifier.

Implementations of any of the described techniques may include a method or process, an apparatus, a device, a machine, a system, or instructions stored on a computer-readable storage device. The details of particular implementations are set forth in the accompanying drawings and description below. Other features will be apparent from the following description, including the drawings, and the claims.

### BRIEF DESCRIPTION OF THE DRAWINGS

FIG. 1 illustrates an example of a system in which a panel of users may be used to perform Internet audience measurement.

FIG. 2 illustrates an example of a system in which site centric data can be obtained by including census measurement in one or more web pages.

FIG. 3 illustrates an example of a system in which panel centric data and site centric data can be used to aggregate data sets for the de-duplication of data.

FIG. 4 is a flow chart illustrating a high level overview of an example process for de-duplicating audience measurement data.

FIG. 5 is a flow chart illustrating further details of an example process for de-duplicating audience measurement data.

FIG. 6 illustrates an example unique viewer report generation process based on the method of FIG. 5.

### DETAILED DESCRIPTION

Statistics (or measures) such as statistics associated with the access of web content may be grouped into one or more classes. A first class of data may be referred to as additive statistics. A defining characteristic of additive statistics are that the statistics grows proportionally to the total telemetry received. These statistics are generally simple to tabulate, as this property enables their aggregation by simply summing over a range. Examples of additive statistics in the context of web content include but are not limited to page views and duration of page views. A page view may be defined as a count of the total number of views of particular content. A duration may be defined as the amount of time that the content is accessed for each page view or for one or more of the page views.

A second class of statistics (or measures) may be referred to as sub-additive statistics. Sub-additive statistics, in contrast, present an obstacle in measurement. In order to exactly calculate an aggregate statistic for a sub-additive metric, all past data may need to be considered to determine whether a given piece of data is new or duplicative. An example of sub-additive statistics includes but is not limited to a unique viewer measure. A unique viewer measure may be defined as the reach of a given website or application to a number of unique viewers over a period of time. While unique viewers and page views are the primary metrics of interest, other unique metrics, such as counts of unique households or unique devices, can be used to measure the consumption of digital media.

The field of digital media consumption measurement and reporting presents numerous challenges that make it difficult to produce reliable data metrics in a timely fashion. Data is typically assembled from a variety of heterogeneous data sources, each having different schemas, data quality characteristics, and/or time resolutions. These datasets may be high velocity and are becoming increasingly immense (e.g., trillions of events per month). Moreover, reported metrics will by necessity change over time due to the constantly evolving nature of the Internet. For example, invalid traffic (IVT) plays a major role in the Internet, and fraud techniques are constantly evolving.

A major challenge that arises in audience measurement, including crossmedia measurement, is that of audience de-duplication. A single user may access the Internet from many devices, including a desktop computer, a smartphone, a tablet, a laptop, a smart TV, and so on. This is the challenge of crossmedia measurement. Each of these devices may present one or more identifiers (e.g., web cookies or advertising identifiers) associated with the access of content by that device. Determining a number of unique viewers of content accessed by that device may require de-duplicating across the number of identifiers. For example, if a web cookie and an advertising identifier are assigned to the same grouping, they may account for a single unique viewer.

Real-time audience de-duplication presents even further challenges. One of the major difficulties that arises in real-time audience de-duplication is the processing of non-real time or historic groupings. Inferred groupings derived from rear-looking data processed in batches at a periodic cadence (e.g., weekly) may not include the identifiers associated with the event, as the identifier itself may have never been observed previously. A new identifier implies either a new unique viewer is accessing content, or a previously observed visitor is accessing content with an identifier new to the dataset. Making this determination in real time requires determining if the identifier corresponds to a new grouping or an existing one.

Disclosed herein are methods and systems that enable reporting on content (e.g., Internet content or application content) viewership in the aggregate. Rather than using standard panel-based methods to approximate unique viewers and page views, a census-based methodology may be utilized (that may or may not be supplemented and combined with panel measurement), thereby drastically reducing variance and susceptibility to non-representative samples.

The methods described herein may rely on the use of a group key to de-duplicate audience data in order to solve one or more problems associated with crossmedia measurement. The group key may include, for example, a user identifier which may correspond to one or more device identifiers. These device identifiers may be grouped together and de-duplicated based on the group key (e.g., the user identifier). Additional techniques may be employed, such as the use of a data structure based on Bloom filters to significantly reduce storage at the cost of accuracy. Exact aggregate statistics may be computed by storing records of all past viewership, but by using a probabilistic data structure such as a Bloom filter, we can tune the false positive rate for membership queries at the cost of extra storage, yielding an approximate but bounded estimate of the aggregate statistic but with much lower storage usage. This approach may be integrated into more advanced techniques, such as missing data estimation, an inevitable problem in Internet measurement. A de-duplication technique is disclosed that, without loss of generality, can be supplied with any grouping of identifiers to produce unique viewer and page view counts for content such as Internet content.

As discussed above, content accessed by client systems may be recorded using either a panel-based approach or a census-based approach. Those accesses may be analyzed to develop audience measurement reports. A panel-based approach generally entails installing a monitoring application on the client systems of a panel of users. The monitoring application then collects information about the webpage or other resource accesses and sends that information to a collection server.

Data about resource accesses can also be collected using a census-based approach. A census-based approach generally involves associating script or other code with the resource being accessed such that the code is executed when a client system renders or otherwise employs the resource. When executed, the census measurement sends a message to a collection server. The message includes certain information, such as an identifier of the resource accessed.

While panel-based data and census-based data can be used separately to produce audience measurement reports, the panel-based data and the census-based data can additionally, or alternatively, be used together to generate audience measurement reports. Using these data sets together may increase the accuracy of the reports. The following describes examples of systems implementing panel-based and census-based approaches to collecting data about resource accesses, and then describes examples of techniques for using the data collected from both approaches together to generate audience measurement reports.

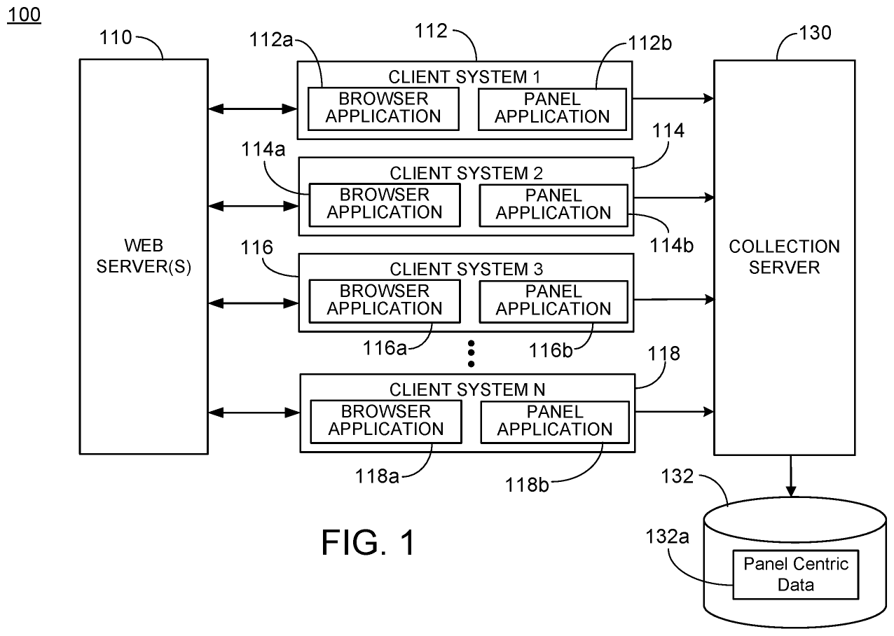

FIG. 1 illustrates an example of a system 100 in which a panel of users may be used to collect data for Internet audience measurement. The system 100 includes client systems 112, 114, 116, and 118, one or more web servers 110, a collection server 130, and a database 132. In general, the users in the panel employ client systems 112, 114, 116, and 118 to access resources on the Internet, such as webpages located at the web servers 110. Information about this resource access is sent by each client system 112, 114, 116, and 118 to a collection server 130. This information may be used to understand the usage habits of the users of the Internet.

Each of the client systems 112, 114, 116, and 118, the collection server 130, and the web servers 110 may be implemented using, for example, a general-purpose computer capable of responding to and executing instructions in a defined manner, a personal computer, a special-purpose computer, a workstation, a server, or a mobile device. Client systems 112, 114, 116, and 118, collection server 130, and web servers 110 may receive instructions from, for example, a software application, a program, a piece of code, a device, a computer, a computer system, or a combination thereof, which independently or collectively direct operations. The instructions may be embodied permanently or temporarily in any type of machine, component, equipment, or other physical storage medium that is capable of being used by a client system 112, 114, 116, and 118, collection server 130, and web servers 110.

In the example shown in FIG. 1, the system 100 includes client systems 112, 114, 116, and 118. However, in other implementations, there may be more or fewer client systems. Similarly, in the example shown in FIG. 1, there is a single collection server 130. However, in other implementations there may be more than one collection server 130. For example, each of the client systems 112, 114, 116, and 118 may send data to more than one collection server for redundancy. In other implementations, the client systems 112, 114, 116, and 118 may send data to different collection servers. In this implementation, the data, which represents data from the entire panel, may be communicated to and aggregated at a central location for later processing. The central location may be one of the collection servers.

The users of the client systems 112, 114, 116, and 118 are a group of users that are a representative sample of the larger universe being measured, such as the universe of all Internet users or all Internet users in a geographic region. To understand the overall behavior of the universe being measured, the behavior from this sample is projected to the universe being measured. The size of the universe being measured and/or the demographic composition of that universe may be obtained, for example, using independent measurements or studies. For example, enumeration studies may be conducted monthly (or at other intervals) using random digit dialing.

Similarly, the client systems 112, 114, 116, and 118 are a group of client systems that are a representative sample of the larger universe of client systems being used to access resources on the Internet. As a result, the behavior on a machine basis, rather than person basis, can also be, additionally or alternatively, projected to the universe of all client systems accessing resources on the Internet. The total universe of such client systems may also be determined, for example, using independent measurements or studies

The users in the panel may be recruited by an entity controlling the collection server 130, and the entity may collect various demographic information regarding the users in the panel, such as age, sex, household size, household composition, geographic region, number of client systems, and household income. The techniques used to recruit users may be chosen or developed to help insure that a good random sample of the universe being measured is obtained, biases in the sample are minimized, and the highest manageable cooperation rates are achieved. Once a user is recruited, a monitoring application is installed on the user's client system. The monitoring application collects the information about the user's use of the client system to access resources on the Internet and sends that information to the collection server 130.

For example, the monitoring application may have access to the network stack of the client system on which the monitoring application is installed. The monitoring application may monitor network traffic to analyze and collect information regarding requests for resources sent from the client system and subsequent responses. For instance, the monitoring application may analyze and collect information regarding HTTP requests and subsequent HTTP responses.

Thus, in system 100, a monitoring application 112b, 114b, 116b, and 118b, also referred to as a panel application, is installed on each of the client systems 112, 114, 116, and 118. Accordingly, when a user of one of the client systems 112, 114, 116, or 118 employs, for example, a browser application 112a, 114a, 116a, or 118a to visit and view web pages, information about these visits may be collected and sent to the collection server 130 by the monitoring application 112b, 114b, 116b, and 118b. For instance, the monitoring application may collect and send to the collection server 130 the URLs of web pages or other resources accessed, the times those pages or resources were accessed, and an identifier associated with the particular client system on which the monitoring application is installed (which may be associated with the demographic information collected regarding the user or users of that client system). For example, a unique identifier may be generated and associated with the particular copy of the monitoring application installed on the client system. The monitoring application also may collect and send information about the requests for resources and subsequent responses. For example, the monitoring application may collect the cookies sent in requests and/or received in the responses. The collection server 130 receives and records this information. The collection server 130 aggregates the recorded information from the client systems and stores this aggregated information in the database 132 as panel centric data 132a.

The panel centric data 132a may be analyzed to determine the visitation or other habits of users in the panel, which may be extrapolated to the larger population of all Internet users. The information collected during a particular usage period (session) can be associated with a particular user of the client system (and/or his or her demographics) that is believed or known to be using the client system during that time period. For example, the monitoring application may require the user to identify his or herself, or techniques such as those described in U.S. Patent Application No. 2004-0019518 or U.S. Pat. No. 7,260,837, both incorporated herein by reference, may be used. Identifying the individual using the client system may allow the usage information to be determined and extrapolated on a per person basis, rather than a per machine basis. In other words, doing so allows the measurements taken to be attributable to individuals across machines within households, rather than to the machines themselves.

To extrapolate the usage of the panel members to the larger universe being measured, some or all of the members of the panel are weighted and projected to the larger universe. In some implementations, a subset of all of the members of the panel may be weighted and projected. For instance, analysis of the received data may indicate that the data collected from some members of the panel may be unreliable. Those members may be excluded from reporting and, hence, from being weighted and projected.

The reporting sample of users (those included in the weighting and projection) are weighted to insure that the reporting sample reflects the demographic composition of the universe of users to be measured, and this weighted sample is projected to the universe of all users. This may be accomplished by determining a projection weight for each member of the reporting sample and applying that projection weight to the usage of that member. Similarly, a reporting sample of client systems may be projected to the universe of all client systems by applying client system projection weights to the usage of the client systems. The client system projection weights are generally different from the user projection weights.

The usage behavior of the weighted and projected sample (either user or client system) may then be considered a representative portrayal of the behavior of the defined universe (either user or client system, respectively). Behavioral patterns observed in the weighted, projected sample may be assumed to reflect behavioral patterns in the universe.

Estimates of visitation or other behavior can be generated from this information. For example, this data may be used to estimate the number of unique viewers (or client systems) visiting certain web pages or groups of web pages, or unique viewers within a particular demographic visiting certain web pages or groups of web pages. This data may also be used to determine other estimates, such as the frequency of usage per user (or client system), average number of pages viewed per user (or client system), and average number of minutes spent per user (or client system).

As described further below, such estimates and/or other information determined from the panel centric data may be used with data from a census-based approach to generate reports about audience visitation or other activity. Using the panel centric data with data from a census-based approach may improve the overall accuracy of such reports.

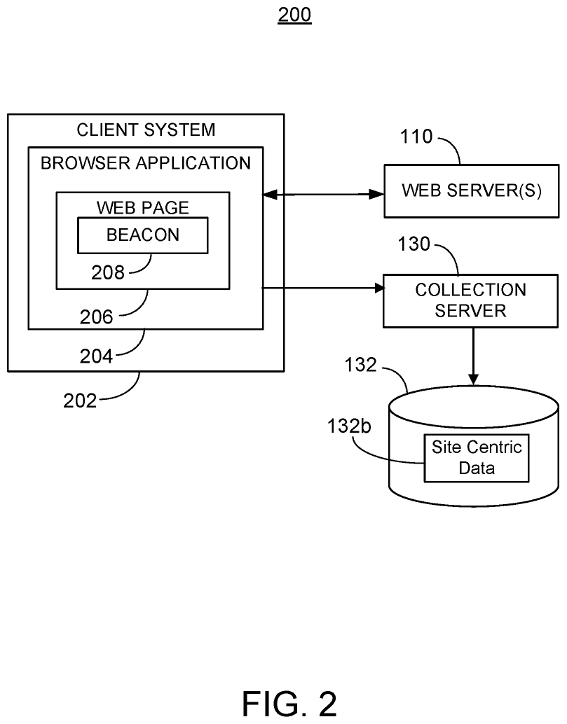

Referring to FIG. 2, a census-based approach may be implemented using a system 200. In general, a census-based approach may entail including census measurement in one or more web pages.

System 200 includes one or more client systems 202, the web servers 110, the collection servers 130, and the database 132. The client systems 202 can include client systems 112, 114, 116, or 118, which have the panel application installed on them, as well as client systems that do not have the panel application installed.

The client systems include a browser application 204 that retrieves web pages 206 from web servers 110 and renders the retrieved web pages. Some of the web pages 206 include census measurement 208. In general, publishers of web pages may agree with the entity operating the collection server 130 to include this census measurement in some or all of their web pages. This code 208 is rendered with the web page in which the code 208 is included. When rendered, the code 208 causes the browser application 204 to send a message to the collection server 130. This message includes certain information, such as the URL of the web page in which the census measurement 208 is included. For example, the census measurement may be JavaScript code that accesses the URL of the web page on which the code is included, and sends to the collection server 130 an HTTP POST request that includes the URL in a query string. Similarly, the census measurement may be JavaScript code that accesses the URL of the web page on which the code is included, and includes that in the URL in the “src” attribute of an <img> tag, which results in a request for the resource located at the URL in the “src” attribute of the <img> tag to the collection server 130. Because the URL of the webpage is included in the “src” attribute, the collection server 130 receives the URL of the webpage. The collection server 130 can then return a transparent image.

The following is an example of such JavaScript:

<script type=“text/javascript”>
document.write(“<img id=‘img1’ height=‘1’
width=‘1’>”);document.getElementById(“img1”).src=“http://
example.com/scripts/report.dll?C7=” + escape(window.location.href) +
“&rn=” + Math.floor(Math.random( )*99999999);
</script>

The collection server 130 records the webpage URL received in the message with, for instance, a time stamp of when the message was received and the IP address of the client system from which the message was received. The collection server 130 aggregates this recorded information and stores this aggregated information in the database 132 as site centric data 132b.

The message may also include a unique identifier for the client system. For example, when a client system first sends a census message to the collection server 130, a unique identifier may be generated for the client system (and associated with the received census message). That unique identifier may then be included in a cookie that is set on that client system 102. As a result, later census messages from that client system may have the cookie appended to them such that the messages include the unique identifier for the client system. If a census message is received from the client system without the cookie (e.g., because the user deleted cookies on the client system), then the collection server 130 may again generate a unique identifier and include that identifier in a new cookie set of the client system.

Thus, as users of client systems 102 access webpages (e.g., on the Internet), the client systems 102 access the webpages that include the census measurement, which results in messages being sent to the collection server 130. These messages indicate the webpage that was accessed (e.g., by including the URL for the webpage) and potentially a unique identifier for the client system that sent the message. When a message is received at the collection server 130, a record may be generated for the received message. The record may indicate an identifier (e.g., the URL) of the webpage accessed by the client system, the unique identifier for the client system, a time at which the client system accessed the webpage (e.g., by including a time stamp of when the message was received by the collection server 130), and a network address, such as an IP address, of the client system that accessed the webpage. The collection server 130 may then aggregate these records and store the aggregated records in the database 132 as site centric data 132b.

The census messages are generally sent regardless of whether or not the given client system has the panel application installed. But, for client systems in which the panel application is installed, the panel application also records and reports the census message to the collection server 130. For example, if the panel application is recording HTTP traffic, and the census message is sent using an HTTP Post message (or as a result of an <img> tag), then the census message is recorded as part of the HTTP traffic recorded by the panel application, including, for instance, any cookies that are included as part of the census message. Thus, in this instance, the collection server 130 receives the census message as a result of the census measurement, and a report of the census message as part of the panel application recording and reporting network traffic.

Because the census message is sent regardless of whether the panel application is installed, the site centric data 132b directly represents accesses by the members of the larger universe to be measured, not just the members of the panel. As a result, for those web pages or groups of web pages that include the census measurement, the site-centric data 132b may serve as the baseline for generating audience measurement data. However, for various reasons, this initial data may include some inaccuracies. As described further below, the panel-centric data 132a can be used to determine adjustment factors that may increase the accuracy of the site-centric data.

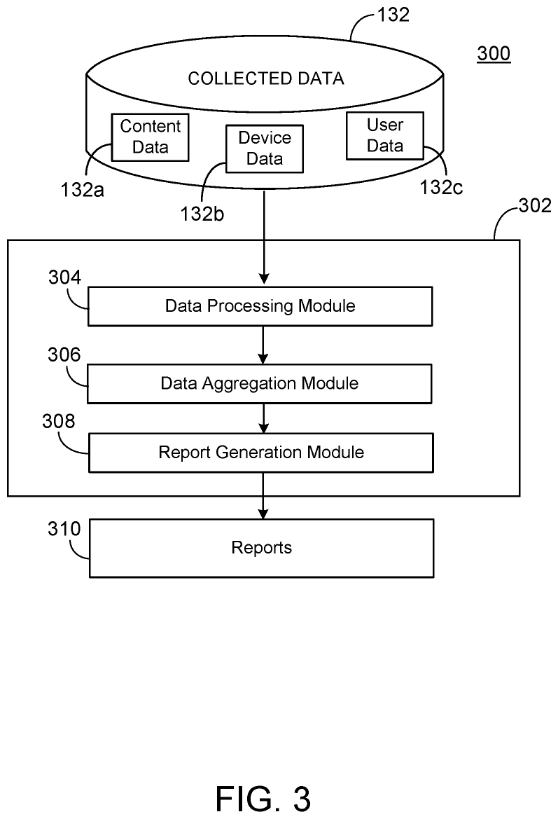

FIG. 3 illustrates an example of a system 300 in which content data 132a, device data 132b, and user data 132c can be used to estimate unique audience viewership of content. Each of the content data 132a, device data 132b, and user data 132c may be collected using the census-based approach discussed above, or using a combination of the census-based approach and the panel-based approach. The system 300 includes a reporting server 302. The reporting server 302 may be implemented using, for example, a general-purpose computer capable of responding to and executing instructions in a defined manner, a personal computer, a special-purpose computer, a workstation, a server, or a mobile device. The reporting server 302 may receive instructions from, for example, a software application, a program, a piece of code, a device, a computer, a computer system, or a combination thereof, which independently or collectively direct operations. The instructions may be embodied permanently or temporarily in any type of machine, component, equipment, or other physical storage medium that is capable of being used by the reporting server 302.

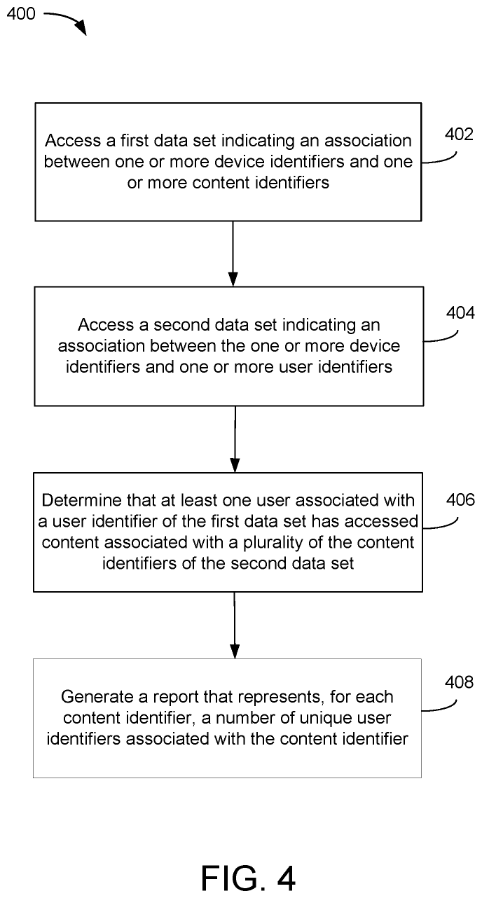

The reporting server 302 executes instructions that implement a data processing module 304, a data aggregation module 306, and a report generation module 308. The data processing module 304 and/or the data aggregation module 306 may implement a process, such as the process shown in any of FIGS. 4, 5 and 6, to estimate a number of unique viewers of content based on the content data 132a, the device data 132b, and the user data 132c. The report generation module 308 may use the aggregated data 306 to generate one or more reports that include information regarding the number of unique viewers of the content.

FIG. 4 is a flow chart illustrating a high level overview of an example process 400 for de-duplicating audience measurement data in order to solve one or more problems associated with crossmedia measurement. The following describes the process 400 as being performed by the data processing module 304, the data aggregation module 306, and the report generation module 308. However, the process 400 may be performed by other systems or system configurations.

The data processing module 304 may access data from the collected data module 132, including one or more of the content data 132a, the device data 132b and the user data 132c. The content data 132a may include one or more identifiers associated with content accessed by a device. The content may include any type of content that is capable of being accessed by a device, such as web content or application content. The device data 132b may include one of more identifiers associated with the device that accessed the content. The device data 132b may include a cookie that is stored on the device in response to the access of the content. The user data 132c may include one or more identifiers associated with a user of one or more of the devices used to access the content. The user data 132 may include a user name or a randomly generated group key (e.g., a user identifier).

At step 402, the data processing module 304 may access a first data set. The first data set may indicate an association between one or more device identifiers and one or more content identifiers. The one or more device identifiers may include one or more identifiers from the device data 132b. The one or more content identifiers may include one or more identifiers from the content data 132a. The first data set may indicate, for each device identifier, a content identifier associated with content accessed by the device. In an example where the device identifier is a cookie stored on the device and the content identifier includes a set of web page URLs, the first data set may list, for each cookie identifier, a list of web page URLs associated with that cookie.

At step 404, the data processing module 304 may access a second data set indicating an association between the one or more device identifiers and one or more user identifiers. The one or more user identifiers may include one or more identifiers from the user data 132c. The second data set may indicate, for each user identifier, a set of device identifiers associated with that user identifier. It is understood that a single user identifier may be associated with one or more device identifiers. For example, an individual user may access content from a desktop computer, a tablet, and/or a cellular telephone.

At step 406, the data aggregation module 306 may determine that at least one user associated with a user identifier of the second data set has accessed content associated with a plurality of the content identifiers of the first data set. The data aggregation module 306 may determine that a user identifier of the second data set corresponds to a plurality of the device identifiers of the first data set, and that each of the device identifiers of the first data set is associated with at least one content identifier of the first data set. The data aggregation module 306 may de-duplicate the data from the first data set and the second data set by creating an association between the one or more user identifiers of the second data set and the one or more content identifiers of the first data set. By matching a plurality of content identifiers with an individual user, the data aggregation module 306 may remove any duplicate access history for the content associated with a given content identifier.

In one example, the data aggregation module 306 may generate a combined data set based on the first data set and the second data set. The combined data set may indicate an association between the one or more user identifiers of the second data set and the one or more content identifiers of the first data set. The combined data set may list, for each user identifier, a combined list of content identifiers accessed by that user.

At step 408, the report generation module 308 may generate a report that represents, for each content identifier, a number of unique viewers associated with the content identifier. For example, a first data set may indicate that content was accessed by five device identifiers. However, the second data set may indicate that the three of the five content identifiers in the first data set are associated with a single user. Thus, the report generation module 308 may de-duplicate the data by creating an association between the content identifiers and the user identifiers, thus removing any duplicate entries for content accessed by a plurality of devices associated with an individual user (e.g., in crossmedia measurement scenarios). The report generation module 308 may indicate, for each content identifier, whether the content was accessed by any of the unique users.

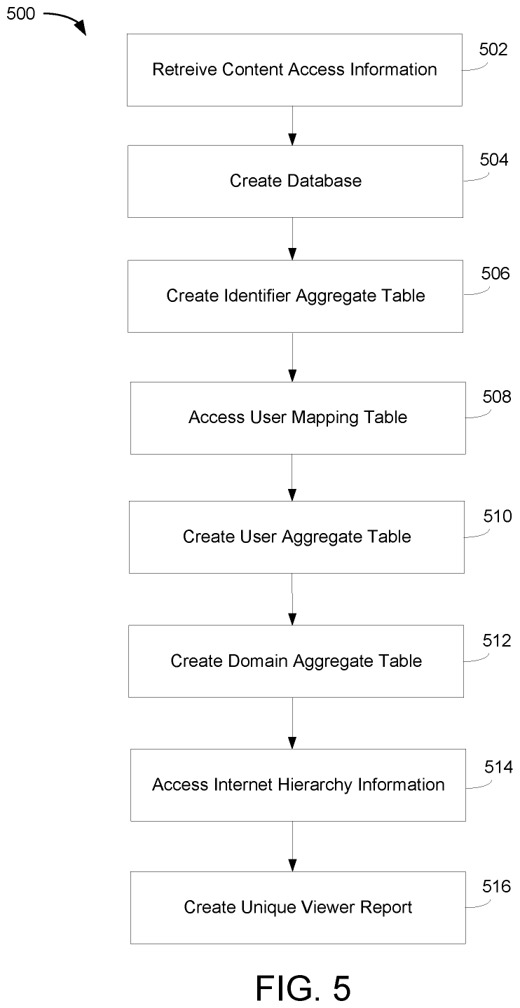

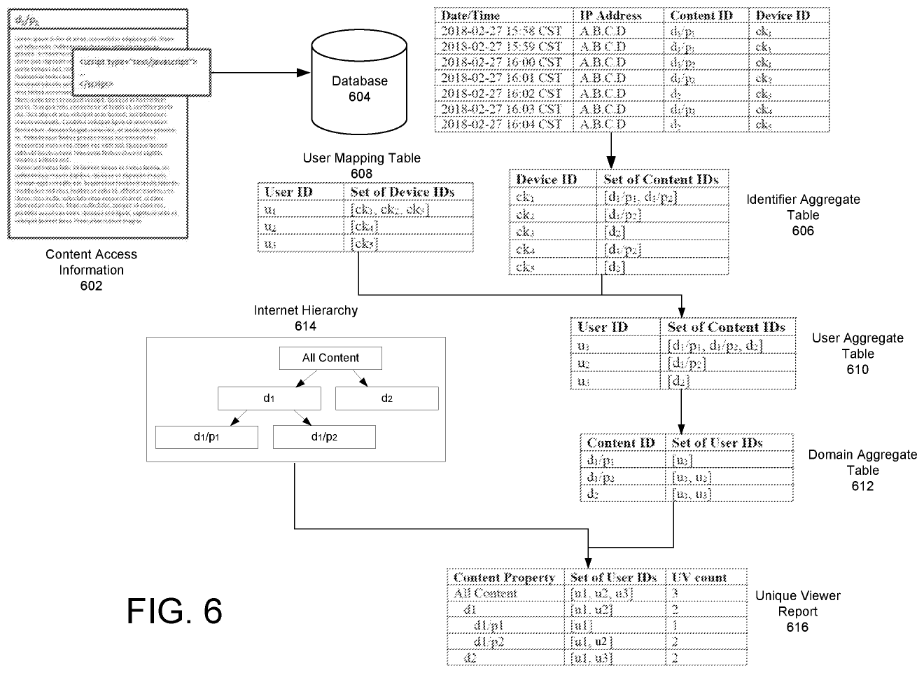

FIG. 5 is a flow chart illustrating details of an example method 500 for de-duplicating audience measurement data. The method 500 may be used to solve one or more of the problems associated with crossmedia measurement as discussed herein. The following describes the method 500 as being performed by the data processing module 304, the data aggregation module 306, and the report generation module 308. However, the method 500 may be performed by other systems or system configurations. The method 500 shown in FIG. 5 and described below may be better understood when viewed in combination with the flow diagram of FIG. 6.

At step 502, the data processing module 304 may receive content access information, such as the content access information 602. The content access information 602 may include one or more of the content data 132a and the device data 132b. The content access information 602 may specify, for each content identifier corresponding to content accessed by a device, one or more of the following: a date and/or time that the content was accessed, one or more content identifiers (e.g., a web page URL), and a device identifier associated with the device that accessed the content. In an example that the content is web content, the content access information 602 may further include an IP address associated with the access of the web content.

In one embodiment, a grouping of device identifiers may be computed prior to the access of the content by one of the devices. A new device identifier, an IP address, and user agent information may also be determined. A projected IP address may be associated with each grouping of device identifiers, when possible. The projected IP address represents an IP address on which identifiers from that grouping are likely to be found at the time of the event. The projected IP address may be determined via collaborative filtering or simple business rules (for example, if a group of device identifiers is always associated with a single IP address for a period).

Next, if the real time event occurs from an IP address that matches a projected IP address, the device identifier may be associated with an existing grouping. Additionally or alternatively, a new grouping may be defined. This determination is derived from an analysis completed in real time, which can include machine learning techniques based on Bayesian learning and community detection. The hypothesis space may be binary: either the device identifier belongs to one of the groupings existing associated with the projected IP address, or the identifier belongs to a new grouping.

Data pertinent to this process may be collected in any number of ways. For example, JavaScript tags may be placed on many of the most popular websites on the Internet. Additionally or alternatively, an SDK (software development kit) may be included into many of the most popular smartphone applications. Through one or more of the techniques, user devices may gather data client-side and send it back to a server-side database. This data might take the form of the content data 132a (e.g., date/time information, IP address information, the URL accessed, etc.). In addition, the data might contain information about the device used to access the URL (e.g., a cookie in the case of the tag, or a unique smartphone identifier in the case of the SDK).

At step 504, the data processing module 304 may create a database such as the database 604 based on the received information. The database 604 may be similar to the database 132 shown in FIG. 1. The data processing module 304 may create a table that associates a content identifier with one or more of the date and time the content was accessed, an IP address associated with the content access, and a device identifier associated with the device that accessed the content. For example, for a content identifier d₁/p₁, the database table may associate with the content identifier a date and time that the content was accessed (e.g., 2018 Feb. 27 15:58 CST), an IP address associated with the access of the content (e.g., A.B.C.D), and/or a device identifier such as a cookie (ck₁) stored on the device that was used to access the content.

At step 506, the data processing module 304 may create an identifier aggregate table, such as the identifier aggregate table 606. The information contained in the identifier aggregate table 606 may be generated based at least in part on the information contained in the database 604. The identifier aggregate table 606 may indicate an association between the plurality of device identifiers and the set of content identifiers. The identifier aggregate table 606 may compile, for each of the device identifiers from the database table 604, a list of the content identifiers associated with that device identifier. For example, as shown in FIG. 6, the identifier aggregate table 606 may indicate that, for the set of content identifiers [d₁/p₁, d₁p₂], a cookie ck₁ was stored on a device used to access the set of content identifiers.

At step 508, the data processing module 304 may access a user mapping table, such as the user mapping table 608. The user mapping table 608 may indicate an association between a group key (e.g., a user identifier) and a set of device identifiers. The device identifiers may correspond to the device identifiers of the database table 604. The user mapping table 608 may indicate, for each of the user identifiers, a set of device identifiers associated with that user identifier. As shown in FIG. 6, the user mapping table 608 may indicate that a first user u₁ is associated with three devices ck₁, ck₂ and ck₃. For example, the user may have access to a desktop computer ck₁, a tablet ck₂, and a cellular telephone ck₃.

At step 510, the data aggregation module 306 may create a user aggregate table, such as the user aggregate table 610. The user aggregate table 610 may indicate an association between a user identifier and one or more content identifiers. The data aggregation module 306 may determine that two or more of the device identifiers of the identifier aggregate table 606 are associated with a single user of the user mapping table 608. Thus, the data aggregation module 306 may determine that the identifier aggregate table 606 contains duplicate entries for a number of “viewers” of the content. While the identifier aggregate table 606 would appear to show that the content was accessed by five different viewers, since in fact three of those device identifiers are associated with a single user identifier, the content was only viewed by three unique viewers. The user aggregate table 610 may associate, with each user identifier from the user mapping table 608, a set of content identifiers associated with the user identifier. For example, the user aggregate table 610 may show that content d₁/p₁, d₁/p₂, and d₂ was accessed by a user associated with the user identifier u₁. In other words, the user accessed a first page of a first website, a second page of a second website, and a second website. Thus, the user aggregate table 610 may de-duplicate the data from one or more of the database table 604, the identifier aggregate table 606 and the user mapping table 608 by grouping the content identifiers with the unique user identifiers rather than the individual device identifiers.

At step 512, the data aggregation module 306 may create a domain aggregate table 612. The domain aggregate table 612 may indicate an association between a content identifier and one or more user identifiers. The data aggregation module 306 may analyze the information in the user aggregate table 610 to determine each individual content identifier and the one or more user identifiers associated with those content identifiers. For example, the domain aggregate table 612 may list, for a first content identifier d₁/p₁, a user identifier u₁ associated with the content identifier. In other words, for a first webpage p₁ associated with a website d₁, only a first user u₁ of the plurality of users have accessed that webpage.

At step 514, the data aggregation module 306 may access supplementary information that indicates a relationship between two or more of the content identifiers. The supplementary information may include Internet hierarchy information, such as the Internet hierarchy information 614. The Internet hierarchy information 614 may indicate a relationship between the plurality of content identifiers. The Internet hierarchy information 614 may include a tree-like structure that indicates a relationship between one content identifier and another one of the content identifiers. For example, the Internet hierarchy information 614 may include a first layer that includes all Internet content that has been accessed by one or more users. The next layer of the tree may indicate one or more websites included in the web content. The websites may include a first website d₁ and a second website d₂. The next layer of the tree may include each of the web pages associated with those websites. There may be a first webpage p₁ and a second webpage p₂ associated with website d₁.

At step 516, the report generation module 310 may generate a unique viewer report, such as the unique viewer report 616. The unique viewer report 616 may indicate, for each of the content identifiers, a set of user identifiers associated with that content and a unique viewer count. For example, the report 616 may indicate that for a first website p₁, a total number of two users u₁ and u₂ that have viewed the content. However, only one of those users u₁ has accessed a first webpage p₁ associated with the website d₁, while both of the users u₁ and u₂ have accessed a second webpage p₂ of the website d₁. Thus, the report generation module 310 may de-duplicate the data accessed by the data processing module 304 by grouping the content identifiers with a number of unique user identifiers that accessed the content, thereby removing any duplicate entries for users that have accessed the content from more than one device (e.g., in situations involving crossmedia measurement).

The techniques described herein can be implemented in digital electronic circuitry, or in computer hardware, firmware, software, or in combinations of them. The techniques can be implemented as a computer program product, i.e., a computer program tangibly embodied in an information carrier, e.g., in a machine-readable storage device, in machine-readable storage medium, in a computer-readable storage device or, in computer-readable storage medium for execution by, or to control the operation of, data processing apparatus, e.g., a programmable processor, a computer, or multiple computers. A computer program can be written in any form of programming language, including compiled or interpreted languages, and it can be deployed in any form, including as a stand-alone program or as a module, component, subroutine, or other unit suitable for use in a computing environment. A computer program can be deployed to be executed on one computer or on multiple computers at one site or distributed across multiple sites and interconnected by a communication network.

Method steps of the techniques can be performed by one or more programmable processors executing a computer program to perform functions of the techniques by operating on input data and generating output. Method steps can also be performed by, and apparatus of the techniques can be implemented as, special purpose logic circuitry, e.g., an FPGA (field programmable gate array) or an ASIC (application-specific integrated circuit).

Processors suitable for the execution of a computer program include, by way of example, both general and special purpose microprocessors, and any one or more processors of any kind of digital computer. Generally, a processor will receive instructions and data from a read-only memory or a random access memory or both. The essential elements of a computer are a processor for executing instructions and one or more memory devices for storing instructions and data. Generally, a computer will also include, or be operatively coupled to receive data from or transfer data to, or both, one or more mass storage devices for storing data, such as, magnetic, magneto-optical disks, or optical disks. Information carriers suitable for embodying computer program instructions and data include all forms of non-volatile memory, including by way of example semiconductor memory devices, such as, EPROM, EEPROM, and flash memory devices; magnetic disks, such as, internal hard disks or removable disks; magneto-optical disks; and CD-ROM and DVD-ROM disks. The processor and the memory can be supplemented by, or incorporated in special purpose logic circuitry.

A number of implementations of the techniques have been described. Nevertheless, it will be understood that various modifications may be made. For example, useful results still could be achieved if steps of the disclosed techniques were performed in a different order and/or if components in the disclosed systems were combined in a different manner and/or replaced or supplemented by other components.

Accordingly, other implementations are within the scope of the following claims.

What is claimed:

1. A method, comprising:
accessing a first data set, the first data set indicating an association between one or more device identifiers and one or more content identifiers;
accessing a second data set, the second data set indicating an association between the one or more device identifiers and one or more user identifiers;
determining, based on the first data set and the second data set, that at least one user associated with a user identifier of the second data set has accessed content associated with a plurality of the content identifiers of the first data set; and
generating, based on the determination, a report that represents, for each content identifier, a number of unique user identifiers associated with the content identifier.

2. The method of claim 1, further comprising generating, based on the first data set and the second data set, a combined data set indicating an association between the one or more user identifiers and the one or more content identifiers, wherein the combined data set associates, for each user identifier, a combined list of content identifiers accessed by that user.

3. The method of claim 2, wherein the content is at least one of web content or application content.

4. The method of claim 3, further comprising accessing supplemental information that identifies, for at least one content identifier, a plurality of web pages associated with the content identifier.

5. The method of claim 4, wherein the report is further based on at least one of the supplemental information and the combined data set.

6. The method of claim 1, wherein the device identifier comprises a cookie stored on the device associated with the device identifier.

7. The method of claim 1, wherein generating the report comprises generating the report in real time or substantially in real time.

8. An apparatus comprising a processor and a memory, the memory storing computer-executable instructions which, when executed by the processor, cause the apparatus to perform operations comprising:
accessing a first data set, the first data set indicating an association between one or more device identifiers and one or more content identifiers;
accessing a second data set, the second data set indicating an association between the one or more device identifiers and one or more user identifiers;
determining, based on the first data set and the second data set, that at least one user associated with a user identifier of the second data set has accessed content associated with a plurality of the content identifiers of the first data set; and
generating, based on the determination, a report that represents, for each content identifier, a number of unique user identifiers associated with the content identifier.

9. The apparatus of claim 8, wherein the instructions, when executed, further cause the apparatus to perform operations comprising generating, based on the first data set and the second data set, a combined data set indicating an association between the one or more user identifiers and the one or more content identifiers, wherein the combined data set associates, for each user identifier, a combined list of content identifiers accessed by that user.

10. The apparatus of claim 9, wherein the content is at least one of web content or application content.

11. The apparatus of claim 10, wherein the instructions, when executed, further cause the apparatus to perform operations comprising accessing supplemental information that identifies, for at least one content identifier, a plurality of web pages associated with the content identifier.

12. The apparatus of claim 11, wherein the report is further based on at least one of the supplemental information and the combined data set.

13. The apparatus of claim 8, wherein the device identifier comprises a cookie stored on the device associated with the device identifier.

14. The apparatus of claim 8, wherein generating the report comprises generating the report in real time or substantially in real time.

15. A computer-readable storage medium comprising computer-executable instructions which, when executed by a processor of a device, cause the device to perform operations comprising:
accessing a first data set, the first data set indicating an association between one or more device identifiers and one or more content identifiers;
accessing a second data set, the second data set indicating an association between the one or more device identifiers and one or more user identifiers;
determining, based on the first data set and the second data set, that at least one user associated with a user identifier of the second data set has accessed content associated with a plurality of the content identifiers of the first data set; and
generating, based on the determination, a report that represents, for each content identifier, a number of unique user identifiers associated with the content identifier.

16. The computer-readable storage medium of claim 15, wherein the instructions, when executed, further cause the device to perform operations comprising generating, based on the first data set and the second data set, a combined data set indicating an association between the one or more user identifiers and the one or more content identifiers, wherein the combined data set associates, for each user identifier, a combined list of content identifiers accessed by that user.

17. The computer-readable storage medium of claim 16, wherein the content is at least one of web content or application content.

18. The computer-readable storage medium of claim 17, wherein the instructions, when executed, further cause the device to perform operations comprising accessing supplemental information that identifies, for at least one content identifier, a plurality of web pages associated with the content identifier.

19. The computer-readable storage medium of claim 18, wherein the report is further based on at least one of the supplemental information and the combined data set.

20. The computer-readable storage medium of claim 15, wherein generating the report comprises generating the report in real time or substantially in real time.
